(19) United States
(12) Patent Application Publication
(10) Pub. No.: US 2007/0242955 A1
(43) Pub. Date: Oct. 18, 2007

(54) Optical Wireless Communications Using Ultra Short Light Pulses and Pulse Shaping

(75) Inventor: Mohsen Kavehrad, State College, PA (US)

Correspondence Address: GIFFORD, KRASS, SPRINKLE,ANDERSON & CITKOWSKI, P.C, PO BOX 7021, TROY, MI, 48007-7021, US

(73) Assignee: The Penn State Research Foundation, University Park, PA (US)

(21) Appl. No.: 11/569,923

(22) PCT Filed: Jun. 1, 2005
(86) PCT No.: PCT/US05/19191

§ 371 Date: Dec. 5, 2006

Related U.S. Application Data
(60) Provisional application No. 60/575,849, filed on Jun. 1, 2004.

(51) Int. Cl. H04B 10/00

(52) U.S. Cl. 398/130

(57) ABSTRACT

An optical, wavelet-based fractal modulation of ultra-short light pulses is used as part of a high-bandwidth communications system. The preferred embodiment utilizes the scheme as part of a hybrid wireless optical and RF transmission system for broadband communications among fixed and/or mobile platforms. An ultra-short pulse laser, high-power WDM-ARRAY laser or high-power incoherent light sources may be used. Computer-generated hologram techniques are employed in designing the optical transceiver subsystems for spectral encoding and decoding of wavelet patterns. Part of the design goal is to select a diversity receiver Field-of-View (FOV) in a way that the effects of scintillation are reduced by as much as possible. Compared to existing optical wireless systems, the invention offers a much higher average transmission bit rate and a much smaller bit error rate outage value, thus enabling highly available FSO links. Wireless transceiver will be capable of communications with nearly line-of-sight FSO links and will be more tolerant to shadowing. Also, the optical medium is designed to be more secure than counterparts against any intrusion.

### REFERENCE TO RELATED APPLICATION

This application claims priority from U.S. Provisional Patent Application Ser. No. 60/575,849, filed Jun. 1, 2004, the entire content of which is incorporated herein by reference.

### FIELD OF THE INVENTION

This invention relates generally to optical communications and, in particular, to an optical, wavelet-based fractal modulation of ultrashort light pulses associated with a hybrid wireless optical and RF transmission system for broadband communications among fixed and/or mobile platforms.

### BACKGROUND OF THE INVENTION

Wireless optical communications links are promising as broadband links. Transmission rates of up to 2.5 Gbps over a link of 4.4 Km have been reported [1-2]. Also, narrow optical beams can minimize interference, making these links difficult to tap, thus providing inherent security, which has been a point of major concern and a focus point for current research efforts. However, wireless optical links are most vulnerable to fog, cloud, mist and dust particles, and relatively less vulnerable to rain. As proposed in [3] and by the Kavehrad in [4-5], to be able to provide a near continuous availability, wireless optical link may be augmented and combined with a radio frequency (RF) link that is not subject to outage during the same weather conditions. Dispersive fading of a line-of-sight (LoS) RF link is a clear-weather phenomenon, and its performance is degraded during rain. This makes an RF carrier a suitable diversity link.

A great challenge in providing a near continuous availability for combined RF and optical wireless links is the low capacity of RF, relative to that of optical wireless link. A multi-input multi-output (MIMO) arrangement in this case will not increase the RF link capacity, as the routes are highly correlated due to line-of-sight links nature in this application. Hence, as such, routing traffic between the RF and wireless optical links during down time of the latter requires massive buffering. Therefore, it seems highly desirable to increase the availability of the optical link. Ultimately, if the optical channel outage is minimized, there is a lesser need for an RF backup link and a complex router design for use between the two links. Accordingly, increased-availability optical wireless link design is a desirable goal.

Pure atmosphere represents a relatively clear medium for a transiting beam of light, typically 1 dB of loss per kilometer (horizontally), is the accepted value. In vacuum, this transmission distance can grow to billions on kilometers and is really only limited by the inverse square law of spherical wave power dispersion. Photons tend to travel in a straight line until they hit something, are absorbed, reflected or refracted. Water as liquid droplets (rain, fog and snow) suspended in the atmosphere is a medium that presents three loss mechanisms in which; two are optical, and one is molecular. These are classified as geometric scattering, Mie scattering and molecular absorption. Liquid water attenuation for 1.5-micron light is very many decibels per meter. The common thread among these attenuation mechanisms is the atomic/molecular coupling properties between light and matter—more specifically, the light waves electrical field and the molecules dipole (in the case of water).

Research into high-speed ultra-short pulsed lasers and their interaction with matter indicates there may be opportunities using ultra-short pulse-shaped techniques to condition the molecular dipole orientation to favor the photons transit through molecule rather that its absorption [6-7]. A number of short pulse techniques are under consideration and ripe for further investigation. If successful, the reduced loss of laser energy due to atmospheric attenuators would be a vital element in the expansion of wireless optical based communications.

Network-centric military operations require unfettered, high data rate connectivity among mobile combatants and command centers within and outside the combat theaters. Global reach is essential. Resources must concentrate on frequently changing crisis regions. Transmissions must be reliable, secure, and inconspicuous. Wireless mobile networks have global reach and can quickly focus resources on different regions. On the other hand, networks are sensitive to jamming, electronic counter measures (ECM), and interception. The adoption of wireless technology for military use demands developing reliable communication systems and technology. Network must adapt at multiple layers and scales. Current technology is inadequate for military needs. Robust mobile military networks require advances in many areas of transmission and networking.

Indeed, as the wireless/mobile systems become more critical in their application, the possibility of intentional disruption becomes more likely as well. Thus, such systems must cope with both natural and man-made interference, which take the form of benign co-channel transmissions and intentional jamming. Existing communication systems were designed with traditional forms of interference that occur as a result of natural phenomenon or other man-made communication systems.

Current research in wireless communication has focused on spatial-temporal diversity techniques (including coding) in an effort to increase transmission capacity and quality-of service. Traditional modes of diversity include time, frequency, polarization, space, angle, field and multi-path. Fundamental to the study of wireless communications is the realization that channel conditions may vary widely and frequently due to fading and that receivers may be located in the areas that do not allow optimal communications due to shadowing. The design of a wireless network begins with a link budget analysis that incorporates margins allowing the network to meet the required bit error rate (BER) despite deep fades and severe shadowing.

In atmospheric free-space optical (FSO) communications, turbulence-induced random fluctuations in the atmosphere's temperature generate corresponding random irregularities in refractive index. In passing through such irregularities, wave-front associated with an optical field is distorted. These distortions are observed in many respects such as broadening of beam beyond the broadening due to diffraction, beam wander defined as random variations of the position of beam centroid and redistribution of the beam energy within the cross section of the beam leading to irradiance fluctuations [8].

Several measures can be employed at the transmitter and receiver to minimize these effects on the optical beam. For example, to mitigate the effect of beam spreading and irradiance fluctuations, receiver usually employs aperture averaging through use of a lens and a detector combination. In addition to already mentioned impairments, existence of turbulence cells and clouds on the path of the optical beam traveling through atmosphere introduces additional degradation in the wave-front, as arriving at receiver, that further degrades signal quality.

Atmospheric temperature variations and wind-speed fluctuations create local unstable air masses causing them eventually to break up into turbulent cells of many different scale sizes and refractive indices. The inhomogeneous refractive properties of the cells conspire to force the traveling optical beam of coherent and collimated light to break up into multiple beam elements each with their independent path trajectories as shown in FIG. 1. These now independent beam paths continue to be increasingly diverted from their original ideal ray path until they either miss entirely or are captured by the receiving optics of the FSO receiver, ray divergence may add up to 100 micro-radians in extreme conditions.

The optical properties of the receiving optics (usually designed for far field focus) collect these independent ray paths and attempt to converge them to a point of common focus, but since the rays arrive at the receiving optics with their own non-ideal angle of entry, geometric receive optics will not be able to focus all these independent rays on a common point of focus that would ideally be defined by the diffractive properties of the optics. Rather, the resulting focus will be an enlarged dynamically changing blur spot many times larger than what the receive optics is capable of forming and usually containing constructive interference formed hotspots and destructive interference fade spots moving randomly around within the blur diameter.

This atmospheric “reality” condition would not be a problem for non-image forming applications except that high speed telecom-grade photo-detectors and or single mode fibers are usually very much smaller than this resulting blur spot which intern means these “receiver” surfaces would experience considerable geometric spread loss and deep but dynamically changing fades due to associated moving scintillation (constructive/destructive interference) patterns.

Transmission medium for FSO links can be thought of as time-varying attenuators between transmitter and receiver. The path attenuation is weather dependent, being at its lowest during clear weather, and increases in the presence of fog, snow or rain. Below is presented a more detailed overview on the time-varying nature of an FSO channel.

In FSO links, the attenuation of light by atmosphere results from two independent mechanisms, scattering and absorption. Scattering refers to any random process by which the directions of individual photons are changed without altering their properties. Absorption includes thermodynamically irreversible processes by which energy of photons is transformed into a thermal energy. This is the major absorption mechanism in the atmosphere and it varies significantly with wavelength. The principle atmospheric absorbers are the molecules of water, ozone and carbon dioxide; these molecules selectively absorb radiation by varying vibrational and rotational energy states. Fortunately, the two gases which are abundantly present in the earth's atmosphere namely oxygen and nitrogen do not exhibit molecular absorption bands. Several windows of low attenuation regions are available; the one of most interest is the window surrounding 1.55 μm, which is highly used in the current optical fiber systems, and with readily available off the shelf components.

Scattering of light in atmosphere is dependent on the relative size of the scattering element to the wavelength; scattering elements with diameters smaller than the wavelength—typical of air molecules—leads to Rayleigh scattering, while scattering elements with diameters comparable to the wavelength such as aerosol scattering elements scatter light in accordance to the Mie theory. Scattering elements that are relatively large such as water droplets found in fog, clouds, rain or snow, the scattering process is described through the diffraction theory.

For Rayleigh scattering, the scattering cross section is inversely proportional to the fourth power of the wavelength, thus for wavelengths beyond 1 μm, Rayleigh scattering is no longer important in comparison to molecular absorption, and may be neglected. The constant availability of aerosol particles and small water droplets in atmosphere, give way to Mie scattering; the attenuation in the spectral range from 0.3 μm to 4 μm due to Mie scattering by far exceeds that due to ozone absorption and Rayleigh scattering and thus is the dominant factor.

In the presence of thick clouds that constitute a highly absorbing medium for optical waves, the reliability of optical component of the system degrades rapidly, thus less dependence on its capabilities is expected. Nonetheless, it is our belief that the FSO links should be maximally utilized according to channel conditions through rate adaptation and traffic bifurcation between the FSO and RF links. Maintaining a continuous transmission on the FSO links during the presence of thick clouds even at low rates, would provide the system with the advantage of being able to grab the opportunity of availability of narrow windows of “good” channel conditions to send burst of high data rates and thus help relieve network congestion and maximize overall network throughput.

In situations in which parts of the optical channel contain clouds such air-to-air or air-to-surface communications, the optical signal is subjected to distortion through temporal broadening. Temporal broadening of optical pulses through clouds has been thoroughly investigated. It has been demonstrated that transmitted optical pulses experience considerable temporal broadening, as they travel through thick clouds [9-10]. Temporal broadening may result in intersymbol interference (ISI), and degradation of received signal quality [11]. Transmission at rates exceeding the channel coherence bandwidth introduces temporal broadening and consequently, ISI. Thus, in order to achieve acceptable signal quality at the receiver, adaptive methods have to be employed to mitigate the effect of ISI, or adaptive transmission rate techniques must be used to keep the rate below the optical channel coherence band at all times.

The temporal impulse response of a wireless optical channel impaired by clouds is well defined by a double gamma function [9-10]:
h(t)={k₁(c₁)t exp[−k₂(c₁)t]+k₃(c₁)t exp[−k₄(c₁)t]}U(t)
where c₁ is a parameter defining the physical characteristics of the optical channel such as particulate size distribution, particulate refractive index, geometrical cloud thickness, and radiation wavelength, k₁ through k₄ are the gamma function constants depending on c₁, and U(t) is a unit step function.

The optical power density at the receiver is a function of this temporal broadening, the transmitted power and the receiver aperture, and is given by:
P_{R}(t)={k₁(c₁)t exp[−k₂(c₁)t]+k₃(c₁)t exp[−k₄(c₁)t]}R.P_{T}.U(t)
where P_{R} is the received optical power, R is the receiver power gathering efficiency, and P_{T} is the transmitted power. The delay spread T_{ds} of the optical channel is usually defined by the required time to theoretically receive a certain percentage of the total received power.

The delay spread of atmospheric wireless optical channels has been investigated through measurements [9] and simulations [10], temporal spread values ranging from 0.5 to 2 microseconds were observed corresponding to cloud thicknesses of 200-300 m, respectively. In order to avoid considerable ISI and signal degradation, transmission rates would have to be limited to 0.5-2 Mbps, rates far lower than the capabilities of FSO links.

### SUMMARY OF THE INVENTION

This invention is directed to an optical, wavelet-based fractal modulation of ultrashort light pulses in the design of a wireless optical communication system. In the preferred embodiment the technique forms part of a hybrid optical and RF transmission system for broadband communications among fixed and/or mobile platforms. Although in the preferred embodiment an ultra-short pulse laser is used, a high-power WDM-ARRAY laser or high-power incoherent light sources may alternatively be used.

Computer-generated hologram techniques are employed in designing the optical transceiver subsystems for spectral encoding and decoding of wavelet patterns. Part of our design goal is to select a diversity receiver Field-of-View (FOV) in a way that the effects of scintillation are reduced by as much as possible.

The ultra-short pulse techniques can potentially result in a reduced loss of laser energy due to atmospheric attenuators. This would be a vital element in the expansion of wireless optical based communications.

In comparison with currently available optical wireless systems, this invention offers a much higher average transmission bit rate and a much smaller bit error rate outage value, thus enabling highly available free-space optical (FSO) links. Wireless transceivers according to the invention are capable of communications with near line-of-sight FSO links, and are more tolerant to shadowing. Also, the optical medium is designed to be more secure than counterparts against intrusion.

The benefits and applications of invention include:

1. Mobile and fixed transceivers using ultra-short pulsed lasers and wavelet pulse shaping enable new dimensions of electronic warfare. When deployed covertly in enemy territory; optical transmissions are more secure.

2. Ability of wavelet transform in excising interference from spread spectrum signals under a variety of interference conditions will improve war-fighting effectiveness.

3. Transmitted signals are extremely resilient against time impulse and tone jamming.

4. Transmitted signals are well suited to low-probability-of-intercept (LPI) and provide a cover of secrecy to the communication system.

5. Transmitted signals are inherently suited to Multi-Access communications due to mutual orthogonality feature of wavelets.

6. Feasibility of receiving large volumes of coordinated information from monitored regions via sensor platforms on UAVs. The major barrier to achieving this in the past was the short range and low communications bandwidth of the sensor platforms.

7. The development of methods that will solve the problems in the transmission of large amounts of data.

8. Addressing the hardware limitations of the communications platforms.

### BRIEF DESCRIPTION OF THE DRAWINGS

FIG. 1 is a diagram that shows how the inhomogeneous refractive properties of the cells conspire to force the traveling optical beam of coherent and collimated light to break up into multiple beam elements each with their independent path trajectories;

FIG. 2 is a diagram that shows how holograms for ultra-short pulse shaping using wavelets can be fabricated by conventional optical means;

FIGS. 3 and 4 show the short time duration typical of wavelets and the resulting bandpass shape of Ψ(ω);

FIG. 5 depicts the time-frequency plane, in which multiple copies of a signal are interspersed, allowing high bit rates when a suitably large time-bandwidth product is available.

FIG. 6 illustrates the multi-rate capability of wavelets;

FIG. 7A is a plot of error as a function of normalized timing offset;

FIG. 7B is a plot of timing jitter variance as a function of signal-to-noise ratio (SNR);

FIG. 8A depicts an ultra-short pulsed FSO transmitter according to the invention;

FIG. 8B illustrates an opto-electric FSO receiver;

FIG. 8C is block diagram of a holographic wavelet generator according to the invention;

FIG. 9 shows how a hologram cell pattern is built up through a gradual choice of changes, pixel-by-pixel, from a random initial cell pattern; and

FIG. 10A shows an optical equalizer structure;

FIG. 10B illustrates how an equivalent tapped-delay line, similar to FIR filters, may be used in discrete-domain equalization to model the optical equalizer; and

FIGS. 11A-11D are block diagrams that depict novel coding protocols.

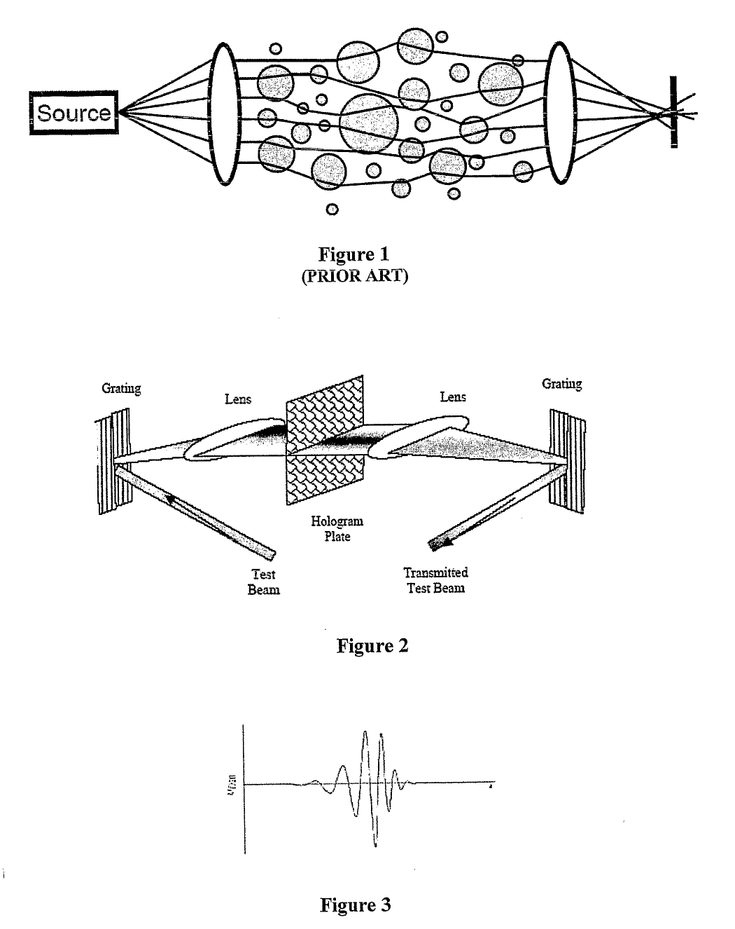

### DETAILED DESCRIPTION OF THE INVENTION

This invention resides in novel optical techniques for wireless optical links. These techniques were motivated by the necessity to mitigate the effects of atmospheric optical channel in order to increase the availability of the optical link. The results achieve higher average bit rates and minimizing combined wireless FSO/RF router design complexity. In particular, the invention achieves time diversity through multi-rate transmission by fractal modulation using wavelets generated by spectral encoding, as applied to ultrashort pulsed laser light, in order to increase the average bit rate over highly variable optical wireless channels. Again, although in the preferred embodiment an ultra-short pulse laser is used, a high-power WDM-ARRAY laser or high-power incoherent light sources may alternatively be used.

Using a multi-rate wavelet transmission approach, the receiver can choose to receive data in clear weather at a few Gbps while it chooses the received signal at lower rates in heavy turbulence. Thus, on the average, a much higher data transmission rate is achievable. To remedy the optical link outage to fading, combined (hybrid) wireless FSO/RF links have been proposed. Extensive performance analysis of a hybrid FSO/RF link, is available in [4-5]. Results show that over a terrestrial path, the hybrid link provides a very small outage value. Below is a summary of the results.

Hybrid Radio Concept

Atmospheric loss is defined as the proportion of the optical power arriving at the receiver, which is captured within the receiver's aperture. Beam divergence is the main contributor to the atmospheric loss; with typical attenuation values of 20 dB/km. Scattering and refraction losses are due to the effects of rain, snow, fog and mist. Scintillation, caused by random variations in refractive index along the propagation path due to solar heating, can also cause the received signal amplitude fluctuate rapidly by as much as 30 dB. Clear air absorption is wavelength dependent, with low loss windows being the same as in optical fibers, centered around the 850 nm, 1300 nm and 1550 nm wavelengths.

On the other hand, in general, dispersive fading of a LoS radio link is a clear-weather phenomenon, and also affected by rain, while weather related optical link outages occur mostly during unclear weather conditions such as in fog, mist, heavy snow, etc. This is not always true, as sometimes fog occurs during the same meteorological conditions that cause frequency-selective multipath fading [12] over terrestrial LoS radio links; this condition occurs when temperature inversions associated with multipath fading tend to trap fog in the lower levels of the atmosphere. Fog as previously mentioned causes outage of an optical link. There could also be other kinds of optical link outages, e.g., an outage due to a thick smoke that may very well occur while the radio link is subject to dispersive fading.

This seemingly anti-correlated relation between the factors detrimental to RF and FSO channels require further in-depth research. Such anti-correlation promises great benefits to augmenting the wireless-optical link with an RF link. The combination would enable provision of an improved level of continuous linkage between transceivers; thus providing an improved guaranteed minimum level of quality-of-service (QoS).

Based on the above observations, some preliminary research was conducted on hybrid terrestrial FSO/RF links, in order to improve the availability of interference-limited LoS microwave links using QAM digital radios [4-5]. During times of wireless optical link outage, the radio channel is assumed to be subject to small-variance flat fades. Such scintillations are characterized by a lognormal probability density function [13]. There is also possibility of fades with a larger flat component and a shallow-notch superimposed on the flat part. Measured data [14] show that the standard deviation of the fading amplitude density function covering both types of fades may range to 7 dB. In addition, the radio link is subject to RF interference. The signal-to-interference (amplitude) ratio follows a lognormal density with a 60 dB mean and a standard deviation of 4 dB for about 20 percent of the radio channels in the 4 GHz frequency band [14]. Conditioned on the interference amplitude level and use the fact that noise and interference are independent, the signal-to-noise-plus-interference ratio (SNIR) can be expressed as

$$SNIR \vert I = \frac{SIR \cdot {γ}_{o}}{SIR + {γ}_{o}} \cdot {α}_{r}^{2} \qquad ( 1 )$$

where in Eqn. (1), SIR is the signal-to-interference power ratio, γₒ is the un-faded SNR at the receiver and is the lognormal flat fade level on the radio channel.

The intensity of an optical beam propagating through a turbulent atmosphere has been characterized by a random variable whose logarithm follows a Gaussian probability density function with a standard deviation that in decibels will extend to 25 dB in strong turbulence.

Table II illustrates the average BER outage in seconds per year for the threshold objective average bit-error-rate (BER) values of 10⁻⁹, for various fading conditions on the FSO and RF channels. Fading parameter in the table is the standard deviation of lognormal attenuation factors on the two channels. As observed in Table I, for a threshold objective BER=10⁻⁹, the maximum outage is about 80 seconds per year. It should be noted that the numbers presented in the Table are for raw data transmission, i.e., no channel coding was used. A greater improvement in performance is expected, with efficient use of channel coding.

The simplified analysis presented above shows the great potential a hybrid FSO/RF link holds. Further in-depth investigation for this link is required to unveil the true potential.

TABLE I
Average BER outage seconds per year for various fade levels on the RF
and FSO channels for a threshold BER = 10⁻⁹, SIR = 60 dB
and a σ_{SIR} = 4 dB

| | |
|---|---|
| σ Optic | σ Radio dB |

| dB | .5 | 2.5 | 5 | 7 |
|---|---|---|---|---|
| 13.0 | 0 | 4 × 10⁻⁵ | 4 × 10⁻² | 5.3 |
| 17.4 | 0 | 2 × 10⁻⁴ | 2 × 10⁻¹ | 32.6 |
| 21.7 | 0 | 6 × 10⁻⁴ | 6 × 10⁻¹ | 80 |

Although such a hybrid system provides an attractive performance in terms of reliability, it still suffers from the bottleneck imposed by the capacity of RF link and the vulnerability of FSO link. By providing a more reliable FSO link, increase of several orders in the system average transmitted bit rate can be achieved at a similar performance level.

FSO Link Outage Reduction Techniques

Pure atmosphere represents a relatively clear medium for a transiting beam of light, typically 1 dB of loss per kilometer (horizontally), is the accepted value. In vacuum, this transmission distance can grow to billions on kilometers and is really only limited by the inverse square law of spherical wave power dispersion. Photons will tend to travel in a straight line until they hit something, are absorbed, reflected or refracted. Water as liquid droplets (rain, fog and snow) suspended in the atmosphere is a medium that present three loss mechanisms, two are optical one is molecular. Rain produces roughly spherical refractive elements (spherical lenses) ranging typically from 500 microns to 5 millimeters in diameter. An optical beam (ray) passing through the exact axial center of this droplet will pass through relatively unaffected, but parallel rays passing through the rain droplet off center will be strongly refracted and redirected away from the original path, this phenomenon is generally referred to as geometric scattering. Similar effects occur with snow and most particularly with the much smaller and more densely packed fog droplets, where multiple off axis transits through many fog droplets can literally return the beam back on itself—a phenomenon well known with car headlights in fog.

The second loss mechanism is the Mie scattering and is a surface property effect where optical rays and their associated wavelengths molecularly couple to the surface of a particle that is similar in size to the wavelength of light. By molecular interaction (molecular wave guide effect), the photons are routed around the particle—and eventually escaping the particle but also strongly diverged from the rays original path. Fog droplet is an almost ideal Mie scattering mechanism for visible and near IR (0.7 to 10 microns) wavelengths and fog is considered the primary loss mechanism for FSO systems due to its dense particulate nature. Similar effects are seen with millimeter-wave radio and rain.

The third loss mechanism is molecular absorption of specific wavelengths of light. Liquid water and the clear air gaseous atmosphere have the property of absorbing specific wavelengths of light, where the energy of the photon matched the molecular resonance of the molecule and the photons energy is absorbed by the molecule and converted into molecular motion and thermal radiation. The primary gaseous material absorber for light is carbon dioxide (oxygen for millimeter-wave radio 60 GHz). But gas absorption losses are trivial compared to liquid water. Liquid water attenuation for 1.5-micron light is many decibels per meter.

The common thread among these attenuation mechanisms is the atomic/molecular coupling properties between light and matter—more specifically the light waves electrical field and the molecules dipole (in the case of water). Research into high speed ultra-short pulsed lasers and their interaction with matter indicate there may be opportunities using extremely short pulse-shaped techniques to condition the molecular dipole orientation to favor the photons transit through molecule rather that its absorption [6-7].

A number of short pulse techniques are under consideration and ripe for further investigation. If successful, the reduced loss of laser energy due to atmospheric attenuators would be a vital element in the expansion of wireless optical based communications.

Spectral Encoding for Wavelet-Shaped Ultra-Short Pulsed Laser Light

In traditional spread-spectrum systems, electronics and synchronization circuits must operate at rates much higher than the desired information rate [11]. This requirement is not a serious limitation for radio frequency cellular or military communications, since modern electronics can easily attain the required speeds. For optical networks, however, individual channels may operate in the Gbit/sec range; one cannot easily envision performing direct modulation and demodulation and maintaining synchronism on much shorter (picosecond or femtosecond) time scales. Indeed, the severity of the synchronization and device operating speed requirements is a powerful objection against application of traditional spread-spectrum approaches to optical networks. Fortunately, by using passive optical processing techniques, one can perform spread-spectrum coding and decoding without requiring ultrafast devices or ultrafast synchronization.

There are many ways to provide pulse-shaping capabilities, most of which depend on phase and amplitude filtering of the optical frequency components of the pulse. The most straightforward approach is to spatially disperse the optical frequency components through the use of a grating and a lens assembly, then pass the dispersed light through a filter mask and then pass the filtered spectrum through another lens and grating assembly. Through the use of this technique, ultra-short pulse waveforms have been developed for many applications such as spread spectrum communications [15], soliton propagation in optical fibers [16], all optical switching [17], and many other applications.

The spectral holography approach for pulse shaping was analyzed by Mazurenko [18], and demonstrated in the ultra-fast time domain by Weiner et. al. [19, 20, 21]. The experiments were performed using visible ultra-short pulses from a CPM dye laser using a thermoplastic plate as the holographic medium. The use of holography for ultra-short pulse shaping harnesses the capability of providing correlation and convolution operations capabilities for independently varying waveforms, matched-filtering and ultra-short waveform synthesis. Capabilities of such a method have been extensively researched and demonstrated in [19-23].

This Fourier synthesis approach can be used for encoding and decoding of coherent ultra-short pulses. A first pulse shaper, the encoder, contains a pseudorandom phase mask which transfers a pseudorandom phase code onto the spectrum of the incoming pulse. This scrambles the spectral phases of the ultra-short pulse and transforms it into a longer duration, low intensity background pseudorandom noise. Analogous to traditional spread spectrum communications, where encoding is performed in the time domain and the bandwidth is spread in the frequency domain, here encoding is performed in the frequency domain and the pulse is spread in the time domain. The decoder consists of a second pulse shaper with a phase filter equal and opposite to that in the corresponding encoder. Thus, for matched encoders and decoders, the total added spectral phase is zero, and the original ultra-short pulse is restored. On the other hand, if the encoder and decoder phase masks are sufficiently different, then the spectral phases are rearranged by the decoder but not canceled; the decoded signal remains a low intensity noise burst, thus providing Code-Division-Multi-Access (CDMA) capability.

Although the discussion so far has centered around coding of ultrashort laser pulses, spectral coding techniques can equally be applied for manipulation of ultra-broadband incoherent light signals, such as those from light emitting diodes (LEDs) or super luminescent laser diodes. Spectral amplitude coding of light from such broad-line width (incoherent) sources has been proposed as the basis of modified optical CDMA system [24]. Amplitude coding is achieved by using patterned amplitude masks rather than the patterned phase masks. Key to this approach is a scheme for manipulating the amplitude-coded wavelength “chips” in order to sum them at the receiver. CDMA systems based on coding of light from a broad-line-width (incoherent) source would involve simpler devices than ultra-short pulse schemes in all related applications.

Note that practical wireless communication systems must function amongst a plethora of noise sources, both natural and manmade. It is therefore essential that we not only design methods to communicate in the presence of interference sources, but also to actively excise interference at the receiver. Spread spectrum is an ideal form of digital communication due to its inherent immunity to noise, however it too fails in cases of pulsed and multi-tone jamming and wideband interference. We therefore wish to augment the noise immunity of spread spectrum communication by introducing interference excision in the transform domain. Many transforms exist which make possible the separation of the signal and noise, including the Fourier transform and the wavelet transform (WT). An objective of this invention is to quantify the benefits of the WT in excising interference from spread spectrum signals under a variety of interference conditions.

Optical schemes have some inherent advantages when dealing with continuous signals. In terms of computation applications, optics has had difficult time to compete with electronics in the digital domain. The strength of optics is its capability to deal with continuous signals. Optical continuous wavelet transform could deliver something, which cannot otherwise be accomplished by digital electronics. It has been shown that the orthonormal wavelet decomposition is based only on discrete translations and dilations. The discrete wavelet transform is not shift invariant. A slight shift can result in drastic changes in obtained wavelet coefficients. This could be a drawback in some applications, which prefer or require shift invariance. More specifically, an orthogonal wavelet transform has no redundancy in its signal representation. The redundancy can help reduce sensitivity to noise in many applications. In addition, most digital wavelet transform algorithms are limited to dyadic frequency sampling. On the other hand, optical continuous wavelet transforms can be shift invariant.

In principle, any wavelet function can be encoded using either a Computer Generated Hologram (CGH) or a complex amplitude modulation spatial light modulator. On the other hand, in general, such continuous wavelet transforms cannot be implemented using digital electronics unless their mathematical close forms can be analytically derived for arbitrary input signals. A second advantage associated with an optical wavelet transform is that it can vary the scale parameter rather arbitrarily. As a direct result of being able to generate continuous wavelet transforms, optical methods may hold a competitive edge in terms of implementing an adaptive wavelet transform. The adaptive wavelet transform and the matching pursuits tend to use the best basis functions to signal decomposition. The basis is selected from a library of dictionary waveforms to minimize energy or entropy.

Most of adaptive wavelets have fixed shapes with varying shift and dilation parameters. The Mother Wavelet used in an adaptive wavelet transform is a linear combination of various wavelets with different scales and shifts. Adaptive wavelets are continuous and redundant with the shape adaptively chosen for particular applications. It is believed that through allowing the wavelet-transform to select its own linear transform kernels, the data-driven adaptation can help enhance the signal-to-noise ratio (SNR), and to increase the robustness of the transform. An adaptive wavelet transform can be easily implemented using an optical wavelet transform processor with a feedback loop.

The CGHs for ultra-short pulse shaping using wavelets can be fabricated by conventional optical means, utilizing exposure techniques, where information on a spatially patterned signal beam is recorded on a holographic plate as a set of fringes arising due to interference of a spatially patterned signal beam with a spatially uniform reference beam, later illumination of the hologram with a uniform read out beam reconstructs either a real or conjugate image of the original signal beam as shown in FIG. 2.

Computer generated holograms can produce wavefronts with any prescribed amplitude and phase distribution and have many useful properties. An object is imaginary and need not exist; an ideal wavefront can be computed on the basis of diffraction theory and be encoded into a tangible hologram. Such holograms have been extensively employed in the design of transmitters and receivers for wireless optical communication [25-35], and the use of CGH was employed in several applications; see, for example publications [30] and [33] in which a spot-array generator was a holographic optical element, designed as a CGH.

Ultra-Short Pulse Wavelet Communications

Certain structures will be common to many of the modulation and demodulation schemes associated with the invention. The spatially patterned phase mask used within this setup introduces phase or amplitude shifts among the different spectral components. The number of independent wavelength “chips” available for encoding is at least several hundred and possibly as high as a few thousand. We refer to the number of independent wavelength “chips” produced by the mask as the processing gain. In the case of ultra-short pulses and spectral phase coding, the incident pulse is spread in time by the processing gain. For envisioned pulses in the few hundred femto-second range, the coded pulse is spread to fill a time window of tens up to a few hundreds of picoseconds, with an intensity which is reduced, correspondingly.

In most cases the duration of a coded pulse will be significantly shorter than the inverse data rate (1 nsec for 1 Gbit/sec data rate). This suggests extra degrees of freedom in signal design. One specific possibility is to consider the use of integrated optic tapped delay lines to augment our spectral coding scheme. Such tapped delay lines used in conjunction with spectral encoders could generate several replicas of the spectrally encoded signal within a single bit period. These systems will automatically have a larger time-bandwidth product. Full benefits of a time-bandwidth product (processing gain) that is the product of the number of taps in the optical delay line and the number of wavelength chips in the optical mask can be achieved.

Fundamental to the study of atmospheric optical wireless communications is the realization that channel conditions may vary widely and frequently due to fading and that receivers may be located in the areas that do not allow optimal communications due to shadowing. Design of a wireless network begins with a link budget analysis that incorporates margins allowing the network to meet the required bit error rate (BER) despite deep fades and severe shadowing. As optical channel mitigation techniques are the main focus of this proposal, we will investigate diversity through spectral encoding, as applied to ultra-short pulsed lasers using wavelets. Here, wavelets provide redundant copies of transmitted data across time-frequency plane. Our goal is to design multi-rate communications to allow for communications over a wide range of channel conditions. By choosing the best rate sequence under all channel conditions, receiver effectively increases the average data rate, with a nearly constant BER outage value.

In order to efficiently excise interference from a spread spectrum signal, it is necessary to perform filtering on the signal in a domain that can efficiently distinguish the desired signal from noise [11]. Practically speaking, there are many means by which interference and other undesired signal components can be removed, however the wavelet transform is ideal because it can overcome noise sources that are not localized in either time or frequency. Wavelets are particularly useful in cases of pulsed noise jamming [36]. The term wavelet was introduced in 1982 by Morlet, Arens, et al [37] to describe a unique class of functions with both time and frequency localization. Contributions by Daubechies [38] and others have given rise to a variety of wavelet families, each with different characteristics and applications. Consequently, wavelets are now readily applied to many diverse scientific fields, including digital communications and signal processing. A few examples of the use of wavelets in communications are shown in [39-44]. Our interest is in the application of the wavelet transform to digital communications to improve the performance of spread spectrum communications in non-stationary interference environments, as in this application. Wavelets arose out of the need to perform analysis of signals that are not localized in either time or frequency domain. Fourier analysis is limited by the time-frequency duality property

$$f ( at ) ⇔ \frac{1}{\vert a \vert} F ( \frac{w}{a} ) \qquad ( 2 )$$

where time duration and bandwidth are inversely related. As a consequence, transient signals, or those with sharp discontinuities, cannot be represented compactly in the frequency domain using the Fourier transform. Likewise, the Fourier transform provides no information regarding when a particular frequency component was present. Alternative methods of analysis include the windowed Fourier transform which requires time-limiting a signal before performing the Fourier transform, and permits more localized analysis of both time and frequency signal components. The windowed Fourier transform is not ideal, however, because it introduces distortion due to the shape of the filter that is used to restrict the signal in the time domain. Thus, we desire a tool that will allow signal analysis in both the time and frequency domains. It was out of this void that class of functions known as wavelets were created.

We first introduce a basis, or mother, wavelet ψ(t) which is a real non-zero function over a finite range of t. Our interest is to characterize the requirements through which ψ(t) can be used to both analyze and synthesize L²-functions, defined as functions which are square-integrable,

$${‖ x ( t ) ‖}^{2} = {\int }_{- ∞}^{∞} \vert {x ( t )}^{2} ⅆ t \vert < ∞ \qquad ( 3 )$$

By selecting an appropriate mother wavelet and related parameters, discussed shortly, we may form an orthonormal basis that supports all L²-functions.

Dilations and translations of the mother wavelet can be defined by integer indices m and n, respectively, as shown in Eqn. (4).

$${ψ}_{n}^{m} ( t ) = {2}^{\frac{m}{2}} ψ ( {2}^{m} t - n ) \qquad ( 4 )$$

The concept of dilation is familiar from Fourier analysis, in which fundamental and compressed versions of a sinusoid are used to measure the energy of a signal at many frequencies. In order to uniquely decompose L²-functions as a superposition of many members of a wavelet family, we require orthonormality between wavelets and their translates:

$${\int }_{- ∞}^{∞} ψ ( t ) \cdot ψ ( t - n ) ⅆ t = 0. \qquad ( 5 )$$

From this property we gain the ability to uniquely represent a signal x(t) using the linear decomposition

$$x ( t ) = {\sum }_{m = - ∞}^{∞} {\sum }_{n = - ∞}^{∞} {x}_{n}^{m} {2}^{\frac{m}{2}} ψ ( {2}^{m} t - n ) \qquad ( 6 )$$

where are known as the wavelet coefficients, analogous to Fourier series coefficients. We refer to Eqn. (6) as the inverse discrete wavelet transform (IDWT) or synthesis equation and write it more compactly,

$$x ( t ) = {\sum }_{m , n} {x}_{n}^{m} {ψ}_{n}^{m} ( t ) . \qquad ( 7 )$$

Likewise, the discrete wavelet transform (DWT), or analysis equation, can be written,

$${x}_{n}^{m} = {\int }_{- ∞}^{∞} x ( t ) {ψ}_{n}^{m} ( t ) ⅆ t . \qquad ( 8 )$$

Similar to the discrete Fourier transform (DFT), the DWT allows us to analyze a signal in time and frequency by examining the set of coefficients. Specifically, describes the energy of the original signal x(t) in the region of

Additional properties of a wavelet ψ(t) can take place in the frequency domain, where we define the Fourier transform of ψ(t),

$$Ψ ( ω ) = {\int }_{- ∞}^{∞} ψ ( t ) {ⅇ}^{- jω t} ⅆ t \qquad ( 9 )$$

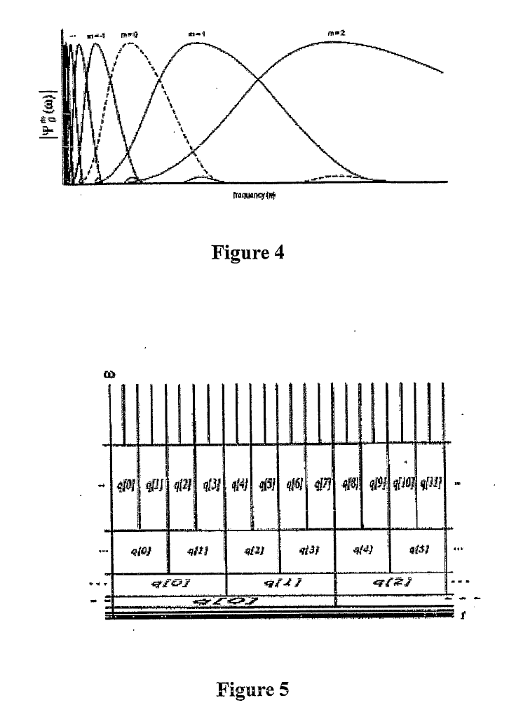

FIG. 3 and FIG. 4 show the short time duration typical of wavelets and the resulting band-pass shape of Ψ(ω).

### Technical Approach

This section describes combined optical and RF wireless communications links motivated by the internetworking of mobile and fixed ground stations, Unmanned Aerial Vehicles, GPS guided munitions, airborne bridges and other platforms.

Optical Fractal Modulation Techniques Using Wavelets

Fundamental to the study of atmospheric optical wireless communications is the realization that channel conditions may vary widely and frequently due to fading and that receivers may be located in areas of the environment that do not allow optimal communication due to shadowing. Most communication systems transmitting over time-varying channels are designed to achieve required performance under the worst-case channel conditions. Usually, to compensate for channel variations, large margins are taken into account at the design stage. A major problem is that such margins do not allow for taking maximum advantage of the available channel capacity, especially in the case of highly variable channels, as an optical wireless channel. In fact, the design process for the worst-case channel capacity results in a variable performance at fixed data rates. Therefore, a worst-case approach in communication system design leads to a poor exploitation of the full channel capacity, so producing suboptimal schemes only.

Although we can resort to adaptive modulation schemes that require feedback from receiver to transmitter, we prefer to employ a less demanding method of channel bandwidth optimization, as adaptive-rate techniques requiring feedback are unsuitable for practical long-distance applications. Such modes of adaptive modulation fail when channel varies rapidly or when channel capacity is scarce, and feedback is not practical.

A viable solution requires a transmission strategy where data to be transmitted can be found in different frequency bands, in order to allow for an efficient reception, when channel condition variations are present. In such a case, the transmitter is not required to change the transmission configuration, while the receiver makes the necessary changes according to these channel variations. This is the basic concept behind fractal modulation, where the transmission spectral efficiency is kept over a broad range of rate-bandwidth ratios using a fixed transmitter configuration. A rather natural strategy of this type arises from the concept of embedding the data to be transmitted into a homogeneous signal.

Here we examine the use of wavelets to provide redundant copies of the transmitted data across the time-frequency plane. Our goal is to provide multi-rate communication over a wide range of optical channel conditions in order to maximize the average transmission rate. By implementing modulation through wavelet transform, we create a transmitted waveform that possesses a degree of self-similarity. Thus, these modulation techniques are referred to as fractal modulation, in reference to the property of self-similarity that fractals possess. In order to achieve diversity through fractal modulation we must devise a method by which we can spread the energy contained in a narrowband signal over a large region in the time-frequency plane.

These waveforms have the property that information is contained within multiple time scales and frequency bands, so they are well suited for transmission over noisy channels of simultaneously unknown duration and bandwidth. In [41], the authors introduced a class of signals that satisfy the dyadic self-similarity property,
x(t)=2^{-kH}x(2^{k}t). (10)
for integer value k. These signals are said to be deterministically scale-invariant and can be classified as dy-homogeneous with a degree H. It has been proposed in [41] that a sequence of data symbols can act as a generating sequence for a waveform x(t),

$$\begin{matrix}\begin{matrix}x ( t ) = {\sum }_{m , n} {β}^{- \frac{m}{2}} q [ n ] {ψ}_{n}^{m} ( t ) \\ = {\sum }_{n} q [ n ] {θ}_{n} ( t )\end{matrix} \\ where & ( 11 ) \\ {θ}_{n} = {\sum }_{m} {β}^{- \frac{m}{2}} {ψ}_{n}^{m} ( t ) \\ and & ( 12 ) \\ β = {2}^{2 H + 1} = {2}^{k} . & ( 13 )\end{matrix}$$

By forming a x(t) in this fashion, redundant information is incorporated in the transmitted signal. FIG. 5 depicts the time-frequency plane, in which multiple copies of a signal are interspersed, allowing high bit rates when a suitably large time-bandwidth product is available. Conversely, when the time-bandwidth product is reduced due to fading and shadowing, the bit rate is reduced. This scheme differs from adaptive methods in that; the transmitter requires no feedback from the receiver to achieve optimal performance. The transmitted signal remains unchanged over time, and the receiver can reconfigure itself based on channel conditions, in order to maximize the throughput of wireless optical link.

Practical considerations require the summations in equations (6) and (11) be formed over a finite set of m and n to fit the maximum available bandwidth and to reduce the computational complexity. The range of n is determined by the time duration of data signal and the width of the wavelet at scale m. Thus, the number of coefficients increases as the time duration decreases corresponding to higher m. Therefore, the use of fractal modulation allows receiver to adapt to wireless optical channel variations by decoding data according to the available channel bandwidth. By maximizing the average bit rate for all conditions, we more fully utilize the channel and effectively increase the average bit rate with a nearly constant BER value. Recently, Kavehrad [44] has shown that transmission systems employing wavelets as basic signaling wave are well suited to utilization in a multi-rate environment.

A point of novelty associated with this invention lies in optical implementation of laser light ultra-short wavelet pulse shaping using CGH masks. The invention also resides in improving the performance of a combined fractal modulation optical and RF transmission system for wireless channels, using equalization and coding protocols. Transmitted signals are extremely resilient against time impulse and tone jamming. Transmitted signals are well suited to low-probability-of-intercept (LPI) and provide a cover of secrecy to the communication system. Transmitted signals are inherently suited to multi-access communications due to mutual orthogonality feature of wavelets.

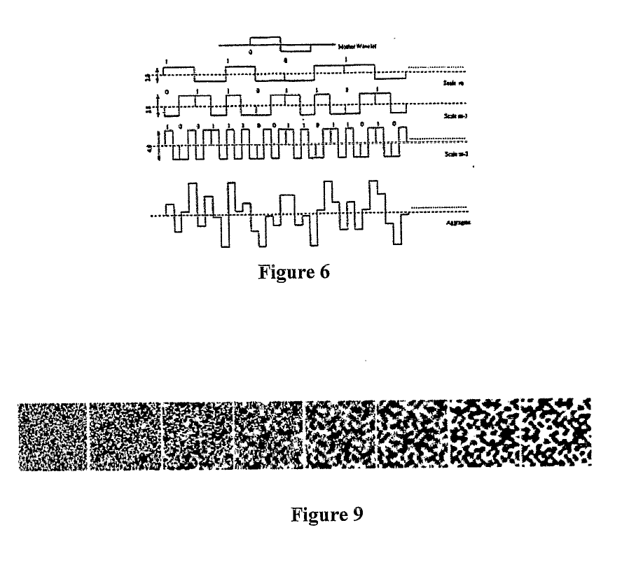

The multi-rate capability of wavelets is depicted in FIG. 6. Three streams are encoded using different scales of a Haar Mother-Wavelets [46]. Each stream can be recovered from the aggregate signal by wavelet transform. Using a CGH following the lens and de-multiplexer grating, we can record data streams at different bit rates on spatially separate wavelength regions. Thus, a WDM of multi-rate signals is created on the CGH mask.

The data stream will be introduced as data packets, as wavelets are particularly suitable for packet transmission [47]. In our simulations [44], we considered the wavelets proposed by Meyer [46], featuring strictly limited bandwidth occupancy. We also investigated the synchronization properties of these wavelets. The probability of error at the output of the receiver as a function of timing error is given by:

$$P ( e ) = P ( e \vert {τ}_{o} ) + \frac{1}{2} {P}^{( 2 )} ( e \vert {τ}_{o} ) \cdot {σ}_{τ}^{2}$$

where P⁽²⁾(e|τₒ) is the second derivative of P(e|τₒ), and τₒ is the optimum sampling point. This relation shows that P(e) is degraded in proportion to the timing jitter variance σ_{τ}². Attention was focused on ML synchronizers, as it will be shown later, this configuration although complex in electronic domain, it can be easily incorporated into our proposed receiver structure. Initially, stability of ML based synchronizers was investigated; to make sure that no false locks are inherent in the system using wavelets as a signaling scheme. The error function used for driving the synchronizer was derived and is given by:

$$e ( k ) = {\sum }_{i} {c}_{i} {c}_{k} {h}^{′} ( ( k - i ) T + \hat{τ} - τ ) - {\sum }_{m = k - D}^{m = k + D} {c}_{i} {c}_{m} {h}^{′} ( ( k - m ) T ) + {c}_{k} {n}^{′} ( kT + τ )$$

Stability is evaluated by observing the zero crossing of the statistical average of e(k), S(δ), which for binary uni-polar signaling is given by:

$$S ( δ ) = ( {C}_{1} - {C}_{2} ) {h}^{′} ( δ ) + {C}_{2} {\sum }_{n} {h}^{′} ( nT + δ ) - {C}_{2} {\sum }_{- D}^{D} {h}^{′} ( nT ) + ( {C}_{2} - {C}_{1} ) {h}^{′} ( 0 )$$

$$where 〈 {c}_{k} {c}_{k + n} 〉 = \{ \begin{matrix}{C}_{1} & n = 0 \\ {C}_{2} & n \neq 0\end{matrix} \}$$

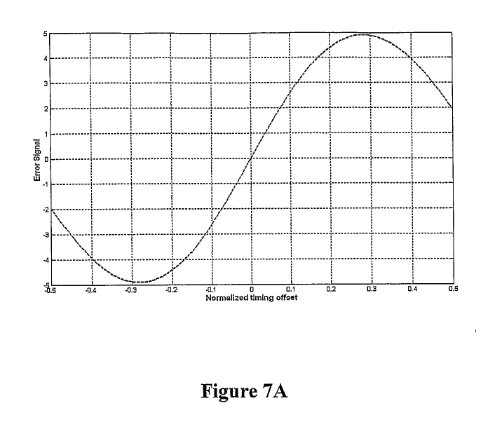

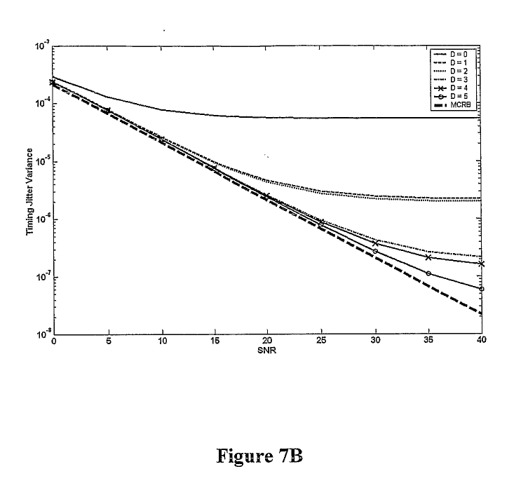

FIG. 7A is a plot of error as a function of normalized timing offset, and FIG. 7B is a plot of timing jitter variance as a function of signal-to-noise ratio (SNR). From these it can be seen that no positive slope-zero crossing occur except at zero timing offset, indicating that a system lock at a false synchronization point will not occur. Following establishing synchronization stability, the variance of the timing jitter was evaluated, and compared to the Modified Cramer Rao Bound (MCRB), which places a lower bound on the variance of an estimated parameter. As shown in the second figure below, using 5 symbol observations for timing estimation, a jitter variance nearly asymptotic to the MCRB can be obtained, with the variance being less the 10⁻⁷ at a SNR of 40 dB. By acquiring the timing jitter variance as a function of the SNR, the probability of error while incorporating timing jitter can be estimated, in the final stages of the project.

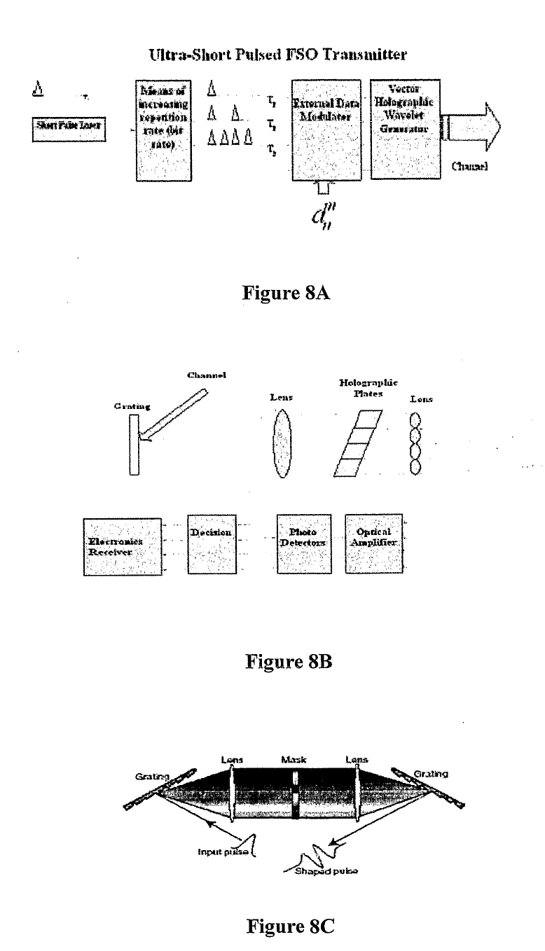

FIG. 8A depicts an ultra-short pulsed FSO transmitter according to the invention. FIG. 8B illustrates an opto-electric FSO receiver, and FIG. 8C is block diagram of a holographic wavelet generator according to the invention. We prefer to use a pulse train generator because each wavelet has a different duration, as there is a factor of 2 time-scaling difference between each two consecutively dilated wavelets. As stated earlier, in principle, encoding a mask having appropriate complex transmission parameters can generate any arbitrary waveform shape. A key element in the synthesis of arbitrary waveforms is the capability of simultaneous and independent modulation of both amplitude and phase levels of the pulse spectral components.

Either a fixed lithographic mask or a spatial light modulator can serve as a pulse-shaping mask. The pulse-shaping mask can be viewed as a special case of a Computer Generated Hologram (CGH), which shapes the input pulse in time domain. The holograms for ultra-short pulse shaping using wavelets can be fabricated by conventional optical means, utilizing exposure techniques, where information on a spatially patterned signal beam is recorded on a holographic plate as a set of fringes arising due to interference of a spatially patterned signal beam with a spatially uniform reference beam, later illumination of the hologram with a uniform read out beam reconstructs either a real or a conjugate image of the original signal beam. Computer generated holograms can produce wave fronts with any prescribed amplitude and phase distribution and have many useful properties. An object is imaginary and need not exist; an ideal wave front can be computed on the basis of diffraction theory and be encoded into a tangible hologram.

To design a phase grating through CGH, an iterative discrete on-axis encoding with simulated annealing can be used [30]. In discrete on-axis encoding, the hologram elementary cell is broken up into a square array of pixels, each imparting a specified phase delay to the incident wave front. Then, the hologram cell pattern is built up through a gradual choice of changes, pixel-by-pixel, from a random initial cell pattern, as shown in FIG. 9. A cost function is minimized by the simulated annealing method. The cost function is defined by the difference between the desired spot pattern and the actual output pattern. Typically, the iteration procedure converges after less than 300 iterations. The actual hologram is a two-dimensional repetition of the elementary cell, an example of this iterative procedure is shown in FIG. 9.

To successfully retrieve the encoded information a receiver matched-filter performing a phase conjugate pulse shaping is used to produce sharp correlation peaks. Essentially, the decoder consists of the same basic functional blocks except that the individual frequency components of the received signal are modulated with the same amplitude but the opposite phase values. To detect a single pre-defined waveform, the received signal is decoded using fixed complex modulation values that are the conjugate of those used for the encoding.

Our design approach, based on our prior experience in this area, [24] through [35], is as follows. Using a holographic encoder mask [48-51], the wavelet pattern is encoded into a collimated light beam for transmission. A proper diffraction angle is chosen to control the total cross-section area of the light beam. This is to ensure power-efficiency in optical transmission. Again, by designing a reasonably wide FOV optical receiver equipped to perform combined, concentration and filtering functions on the received light, we can optimize the photo-detection operation.

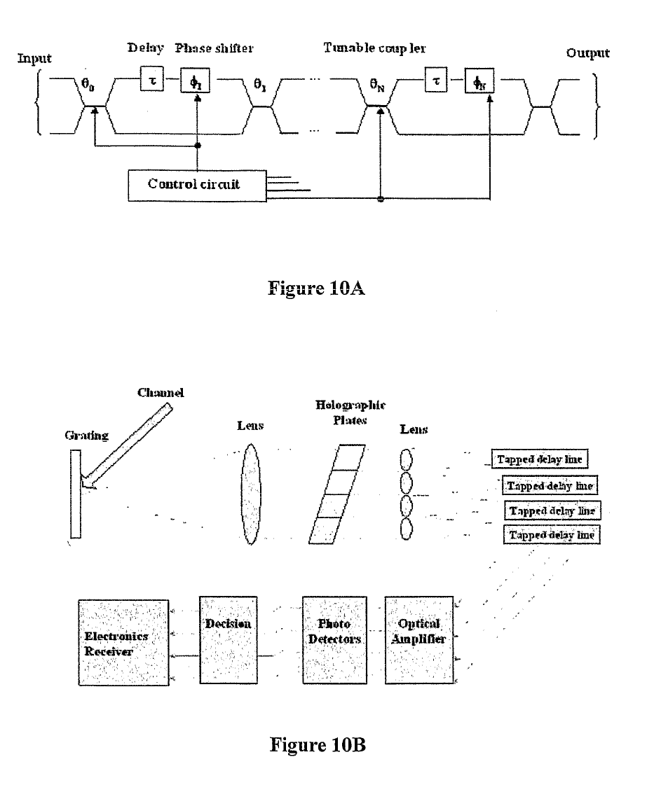

Regarding pulse broadening through clouds, a structure is used to recover the wavelet pulse shapes. We know that pulse shaping in fractal modulation benefits free-space optical communications [44]. Tradeoffs can be considered in the methods for creating such a shaping. Considering that through-cloud optical channel shows a very long memory, use of an equalizer can further enhance the system performance. FIG. 10A illustrates an optical equalizer configured in accordance with the invention. FIG. 10B illustrates how an equivalent tapped-delay line, similar to FIR filters, may be used in discrete-domain equalization to model the optical equalizer. The structure consists of N stages offering time delay, phase-shift, and tunable coupling. In this model, an equivalent tapped-delay line, similar to FIR filters used in discrete-domain equalization, can model the optical equalizer.

We have already seen that in our optical channel model whose signal distortion mostly occur near the low pass region in the frequency domain, wavelet is a good choice compared with conventional square root raised cosine, considering wavelet's band-pass properties. For data rates of 0.3125 Gbps through 2.5 Gbps that we're considering, our numerical calculation shows that the delay spread can rise up to several hundred-symbol durations, even under mild test conditions with short link distances. However, under the wavelet modulation scheme, according to our initial results, equalization turns out to be effective even with a small number of taps not as huge as the numerical delay spread values imply. We believe this is attributable to the compact band-pass properties of wavelets.

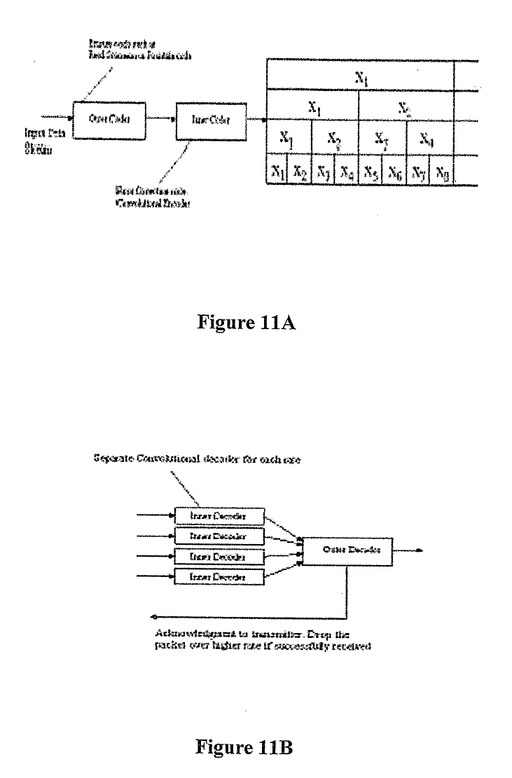

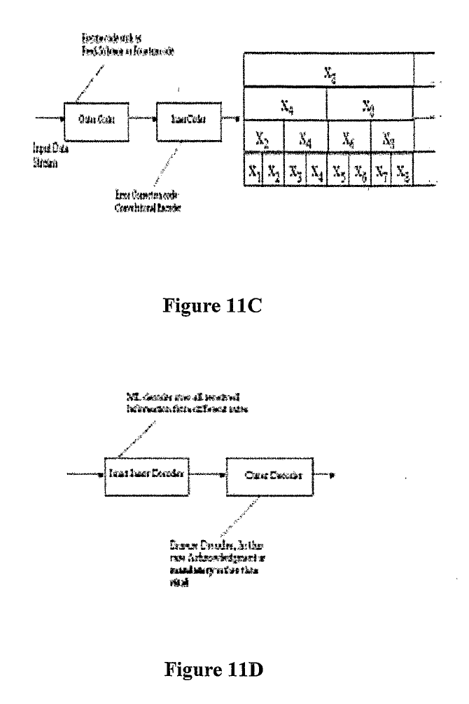

For reliable encoded transmission of information over several parallel rates, we have designed novel protocols for coding, as shown in FIGS. 11A to 11D. Consider for example that we have 4 different bit-streams at rates: 2.5, 1.25, 0.625 and 0.312 Gbps. Our first proposal is based on transmitting the same data on all 4 rates. Once we get the acknowledgement for the highest rate, we drop the information block over lower rates and start to send another frame of data. However, it is possible to achieve yet even a better performance by the following code and protocol scheme. We code a block of B data bits by a convolutional code. Then we send it at the highest rate. For the lower rates, instead of sending the entire block of B bits, we puncture the coded frame and send half of the block over all the lower rates. This hybrid system decreases the coded frame. We have derived performance of the optimum Maximum Likelihood receiver based on all the received data streams. Our simulation results show significant improvement over the first coding protocol scheme that decoded each stream, separately.

We have also examined a concatenated coding scheme that uses a hybrid Automatic Repeat Request (ARQ) and an erasure code. The concatenated coding scheme in conjunction with the ARQ system can achieve both a high reliability and high throughput efficiency.

A fundamental trade-off exists between independence and efficiency (reliability) of designing the protocol. For example, the first protocol that we introduced where the transmitter dropped the blocks of data over higher rates on the acknowledgment, is most reliable in which the streams over different rates can be received, independently. Until now, our emphasis has been on the inner decoder where we have decided to use a Convolutional code for forward error correction. However, there are occasions where the inner decoder fails to capture and correct all the errors, due to a severe channel condition. Consequently, clusters of errors appear in the data stream. These blocks are removed and are retrieved by re-transmissions or using an outer code or a combination of both.

We will now discuss the structure of outer code in a concatenated coding scheme. Normally, a Reed-Solomon (RS) code is used as an outer code in which each block of data is a GF(2^{m}) symbol. An (N,K) RS code maps K source symbols onto N encoded symbols. RS codes recover N coded blocks with N-K number of erased blocks. While RS code can be very effective in terms of reducing the need for ARQ, it is not well matched to our multi-rate system where the blocks of data are received on different rates. Therefore, as a much better solution, we are using Fountain codes. These are a new class of erasure-correcting codes. The codes can produce an unlimited flow of encoding data blocks, i.e., these codes are rate-less. The source data is always recoverable from the required amount of encoded data. Fountain codes can encode very large data blocks, compared to RS where each block is a GF(2^{m}) symbol prohibiting large encoding blocks for complexity of encoding and decoding. What makes Fountain codes especially well suited to our multi-rate system is the flexibility of reception from multiple sources. We think there is enough evidence to consider Fountain codes followed by an inner Convolutional code as the ultimate coding solution in our overall system design.

### Comparison with Ongoing Research

In comparison with any currently available optical wireless transmission system, the invention should result in a significantly greater average transmission rate and a lower BER outage level. The optical wireless configuration will be capable of handling communications over nearly line-of-sight atmospheric links and will be tolerant to any shadowing and blockage.

Ultra-fast switching times and ultra-high transmit powers can enable communication capabilities that by far exceed anything available today. A 30-micron long 100 fs pulse at 100 mJ would produce an average power of 1 Terawatt. Compared to today's nanosecond technology, a Terawatt of average power would require laser energies of 1000 J. Although ultra-short pulse lasers in the 20 fs range have been demonstrated, much research remains to be completed before these can be applied in actual applications. Clearly the interaction of high average power laser pulses with matter is much more difficult to understand compared with nanosecond technology.

A point of novelty associated with the invention lies in optical implementation of laser light ultra-short wavelet pulse shaping using optical/holographic masks. Also unique is the use of a combined fractal modulation optical and RF transmission system for wireless communications channels. Transmitted signals are extremely resilient against time impulse and tone jamming. Transmitted signals are well suited to low-probability-of-intercept (LPI) and provide a cover of secrecy to the communication system. Transmitted signals are inherently suited to multi-access communications due to mutual orthogonality feature of wavelets.

Other inventive steps include the robustness of synchronization, optical equalization and its interaction with correlation and matched-filtering through a phase conjugate mask. The coding protocols further improve the overall performance of the system and method.

### REFERENCES

[1] G. Nykolak, P. Szajowski, G. Tourgee, and H. Presby, “2.5 Gbit/s free space optical link over 4.4 km,” Electronics Letters, Vol. 35, pp. 578-579, April 1999.
[2] G. Nykolak, P. F. Szajowski, J. Jacques, H. M. Presby, G. E. Abate, G. E. Tourgee, and J. J. Aubom, “4×2.5 Gb/s 4.4 km WDM free-space optical link at 1550 nm,” Optical Fiber Communication Conference, 1999, and the International Conference on Integrated Optics and Optical Fiber Communication. OFC/IOOC '99. Technical Digest, Vol. Supplement, pp. PD11/1-PD11/3, 1999.
[3] B. G. King, et al, “An Experimental Study of Atmospheric Optical Transmission,” The Bell System Technical Journal, Vol. 62, No. 3, March 1983.
[4] M. Kavehrad, “Design and Performance Considerations for the Hybrid Atmospheric Optical/Digital Microwave Network Systems,” Technical Memorandum, AT&T Bell Laboratories, December 1987.
[5] M. Kavehrad, “A Countermeasure to Improve Outage Performance of Interference-Limited Microwave Radio Links,” Canadian Journal of Electrical & Computer Engineering, Vol. 16, No. 1, January 1991.
[6] D. R. Alexander and M. L. Rohlfs, “Femtosecond laser pulse propagation through aerosol clouds,” IGARSS '02, Vol.-5, pp. 2631-2633, June 2002.
[7] P. Sprangle, et al., “Propagation of Intense Short Laser Pulses in the Atmosphere,” Journal of Phys. Rev. E 66, 046418, 2002.
[8] L. Andrews, R. Phillips, “Laser Beam Propagation through Random Media,” SPIE Press, 1998.
[9] G. C. Mooradian, M. Geller, L. B. Stotts, D. H. Stephens, R. A. Krautwald, “Blue-Green pulsed propagation through fog,” Appl. Optics, Vol. 18, p. 429, February 1979.
[10] S. Arnon, D. Sadot and N. S Kopeika., “Analysis of optical pulse distortion through clouds for satellite to earth adaptive optical communication,” J. Modern Optics, Vol. 41, No. 8, pp. 1591-1605, August 1994.
[11] G. Proakis, Digital Communications, McGraw-Hill, New York, N.Y., 2001.
[12] Owen N., et al, “Analysis of Multipath Fading Observations on Certain Microwave Paths in British Columbia,” Proceedings of URSI Commission F Symposium, ESA SP-194, European Space Agency, Paris, 1983.
[13] Babler G. M., “Scintillation Effects at 4 and 6 GHz on a Line-of-Sight Microwave Link,” IEEE Trans. on Antenna and Propagation, Vol. AP.19, No. 4, July 1971.
[14] Adenigba A. B., Tsolakis T. A, “Interference Dynamics Considerations in Digital Radio Performance,” Proceedings of ICC'88, June 1988.
[15] A. M. Weiner, J. P. Heritage, J. A. Salehi, “Encoding and Decoding of Femtosecond Pulses,” Opt. Lett., vol. 13, 1988
[16] A. M. Weiner, J. P. Heritage, R. J. Hawkins, R. N. Thurston, E. M. Kirschner, D. E. Leaird, and W. J. Tomlinson, “Experimental Observation of the Fundamental Dark Soliton in Optical Fibers,” Phys. Rev. Lett. 61, 2445-2448, 1988.
[17] A. M. Weiner, Y. Silberberg, H. Fouckhardt, D. E. Leaird, M. A. Saifi, M. J. Andrejco, and P. W. Smith, “Use of Femtosecond Square Pulses to Avoid Pulse Break-up in All-Optical Switching,” IEEE J. Quantum Electron QE-25, 2648-2655, 1989.
[18] Y. T. Mazurenko, “Holography of wave packets,” Appl. Phys. B, Vol. 50, pp. 101-114, 1990.
[19] A. M. Weiner, D. E. Leaird, D. H. Reitze, and E. G. Paek, “Spectral Holography of Shaped Femtosecond Pulses,” Opt. Lett. 17, 224-226, 1992.
[20] A. M. Weiner, D. E. Leaird, D. H. Reitze, and E. G. Paek, “Femtosecond Spectral Holography,” IEEE J. Quantum Electron. 28, 2251-2261, 1992.
[21] A. M. Weiner and D. E. Leaird, “Femtosecond Signal Processing by Second-Order Spectral Holography,” Opt. Lett. 19, 123-125, 1994.
[22] Y. Ding, R. M. Brubaker, D. D. Nolte, m. R. Melloch, and A. M. Weiner, “Femtosecond pulse shaping by dynamic holograms in photorefractive multiple quantum wells,” Opt. lett. 22, 718-720, 1997.
[23] D. D. Nolte, “Adaptive holograms and applications using photorefractive quantum wells,” Lasers and Electro-Optics Society 1999, 12th Annual Meeting. LEOS '99 IEEE, vol. 2, 8-11 Nov. 1999.
[24] D. Zaccarin and M. Kavehrad, “An Optical CDMA System Based on Spectral Encoding of LED,” IEEE Phot. Tech. Lett., vol. 4, p. 479 (1993).
[25] G. Yun, M. Kavehrad, “Spot-Diffusing and Fly-Eye Receivers for Indoor Infrared Radio Communications,” IEEE Int. Conf on Selected Topics in Wireless Communications, Vancouver, June 1992.
[26] E. Simova, M. Tai, M. Kavehrad, “Indoor Wireless Infrared Link with a Holographic Multiple-Spot Diffuser,” Proceedings of ICAPT, Montreal, August 1996.
[27] E. Simova, M. Tai and M. Kavehrad, “Indoor wireless infrared link with a holographic multiple-spot diffuser,” Applications of Photonic Technology, Vol. 2, Plenum Press, New York, pp. 223-228, 1996.
[28] M. R. Pakravan, E. Simova, M. Kavehrad, “Holographic Diffusers for Indoor Infrared Communications Systems,” Proceedings of GLOBECOM, London-England, November 1996.
[29] M. R. Pakravan, E. Simova, M. Kavehrad, “Holographic Diffusers for Indoor Infrared Communication Systems,” International Journal of Wireless Information Networks, Vol. 4, No. 4, pp. 259-274, October 1997.
[30] S. Jivkova, M. Kavehrad, “Indoor Wireless Infrared Local Access, Multi-Spot Diffusing with Computer Generated Holographic Beam-Splitter,” Proceedings of ICC'99, Vancouver, CANADA, June 1999.
[31] S. Jivkova, M. Kavehrad, “Multi-Spot Diffusing Configuration for Wireless Infrared Access; Joint Optimization of Multi-beam Transmitter and Angle Diversity Receiver,” Proceedings of SPIE Conference, Boston, September 1999.
[32] M. Kavehrad, S. Jivkova, “Holographic Spherical Mirror as a Receiver Optical Front-end for Broadband Infrared Indoor Wireless Communications,” U.S. Patent Pending, CICTR, The Pennsylvania State University, 2000.
[33] S. Jivkova, M. Kavehrad, “Multispot Diffusing Configuration for Wireless Infrared Access,” IEEE Trans. on Communications, Vol. 48, No. 6, pp. 970-978, June 2000.
[34] S. Jivkova, M. Kavehrad “Holographic Optical Receiver Front-End for Wireless Infrared Indoor Communications,” OSA Applied Optics Journal, June 2001.
[35] S. Jivkova, M. Kavehrad, “Receiver Designs and Channel Characterization for Multispot High Bit Rate Wireless Infrared Communications,” IEEE Trans. on Communications, Vol. 49, No. 12, pp. 2145-2153, December 2001.
[36] R. L. Peterson, R. E. Ziemer, and D. E. Borth, Introduction to Spread Spectrum Communications, Prentice Hall, Upper Saddle River, N.J., 1995.
[37] J. Morlet, G. Arens, I. Fourgeau, and D. Giard, “Wave propagation and sampling theory,” Geophysics, 47, 1982, pp. 203-236.
[38] I. Daubechies, “Ten lectures on wavelets,” Symposia in Applied Mathematics, Philadelphia, Pa., 1992.
[39] G. Wornell, Signal processing with fractals: A wavelet-based approach, Prentice Hall, Upper Saddle River, N.J., 1996.
[40] D. Cochran, Ch. Wei, “A Wavelet-Based Multiple-Access Spread Spectrum Modulation Scheme,” IEEE 13th Annual International Phoenix Conference on Computers and Communications, April 1994.
[41] G. W. Wornell, A. V. Oppenheim, “Wavelet-based representations for a class of self-similar signals with application to fractal modulation,” IEEE Transactions on Information Theory, Vol. 38, pp. 785-800, 1992.
[42] N. Erdol, F. Bao and Z. Chen, “Wavelet modulation: a prototype for digital communication systems,” Southcon/95. Conference Record, 1995, pp. 168-171.
[43] L. Atzori, D. D. Giusto, M. Murroni, “Performance analysis of fractal modulation transmission over fast-fading wireless channels,” IEEE Trans. on Commun., Vol-48, No.-2, pp. 103-110, June 2002.
[44] M. Kavehrad, B. Hamzeh “Ultra-short Pulsed FSO Communications System with Wavelet Fractal Modulation,” Proceedings of Optics East, Philadelphia Pa., October 2004.
[45] R. E. Ziemer and D. T. Harvatin, “An Overview and Characterization of Multi-rate Schemes for Future-Generation Wireless Systems,” IEEE Sixth International Symposium on Spread Spectrum Techniques and Applications, Vol.-2, Pages: 550-554, September 2000.
[46] G. Kaiser, A Friendly Guide to Wavelets, Boston, Mass.: Brickhauser, 1993.
[47] A. R. Lindsey, “Wavelet Packet modulation for Orthogonally Multiplexed Communication,” IEEE Trans. on Signal Processing, Vol.-45, No.-5, May 1997.
[48] M. Kavehrad, E. Simova, “Optical CDMA by Amplitude Spectral Encoding of Spectrally-Sliced Light-Emitting-Diodes,” Proceedings of IEEE ISSSTA, Mainz-Germany, September 1996.
[49] L. Adam, E. Simova, M. Kavehrad, “Experiment on Optical Code-Division-Multiple-Access Switch System Using Spectral Amplitude Encoding of Light-Emitting Diodes,” Proceedings of ICAPT, Montreal, August 1996.
[50] L. Adam, E. Simova, M. Kavehrad, “Experimental Optical CDMA System Based on Spectral Amplitude Encoding of Non-coherent Broadband Sources,” Proceedings of SPIE Photonics East'95, Philadelphia, Pa., October 1995.
[51] L. Adam, E. Simova, M. Kavehrad, “Experiment on Optical Code-Division-Multiple-Access Switch System Using Spectral Amplitude Encoding of Light-Emitting Diodes,” Paper reprinted in Applications of Photonic Technology-2, Plenum Press, 1997.

I claim:

1. A wireless optical communications system, comprising:
a source of a light pulse;
a transmitter including a modulator for modulating the light pulse with data and an optical mask for transforming the modulated light pulse into wavelets; and
a receiver including an optical mask and demodulator for recovering the data.

2. The wireless optical communications system of claim 1, wherein the source of the light pulse is a laser.

3. The wireless optical communications system of claim 1, wherein the source of the light pulse is a high-power WDM-ARRAY laser.

4. The wireless optical communications system of claim 1, wherein the source of the light pulse is a high-power incoherent source.

5. The wireless optical communications system of claim 4, wherein the incoherent source is an ultra-broadband light-emitting diode or super luminescent laser diode.

6. The wireless optical communications system of claim 1, wherein the optical mask is a holographic optical mask.

7. The wireless optical communications system of claim 1, wherein the receiver can choose to receive data in clear weather at a relatively high data rate and lower rates in the presence of turbulence.

8. The wireless optical communications system of claim 1, wherein the modulation utilizes fractal modulation.

9. The wireless optical communications system of claim 1, wherein the wavelets provide redundant copies of the transmitted data across the time-frequency plane.

10. The wireless optical communications system of claim 1, wherein multiple copies of the data are incorporated in the transmitted signal.

11. The wireless optical communications system of claim 10, wherein the multiple copies are interspersed.

12. The wireless optical communications system of claim 1, wherein the optical mask records data streams at different bit rates on spatially separate wavelength regions.

13. The wireless optical communications system of claim 1, wherein the transmitter and receiver form part of a hybrid wireless optical and RF transmission system.

14. The wireless optical communications system of claim 1, further including an erasure-correcting encoding protocol.

15. The wireless optical communications system of claim 1, wherein the encoding protocol uses Fountain codes.

16. A broadband optical wireless communications method, comprising the steps of:
generating a light pulse;
modulating the light pulse with information;
encoding the modulated light pulse into wavelets;
transmitting the wavelets to a receiver;
decoding the wavelets at the receiver; and
demodulating the pulse to recover the information.

17. The method of claim 16, wherein the steps of encoding and decoding are carried out with optical masks.

18. The method of claim 17, wherein the wherein the optical masks are holographic.

19. The method of claim 16, wherein the receiver can choose to receive data in clear weather at a relatively high data rate and lower rates in the presence of turbulence.

20. The method of claim 16, wherein the modulation utilizes fractal modulation.

21. The method of claim 16, wherein the wavelets provide redundant copies of the transmitted data across the time-frequency plane.

22. The method of claim 16, wherein multiple copies of the data are incorporated in the transmitted signal.

23. The method of claim 22, wherein the multiple copies are interspersed.

24. The method of claim 16, wherein the optical mask records data streams at different bit rates on spatially separate wavelength regions.

25. The method of claim 16, further including the step of providing an RF transmission system acting as a back-up should the optical system experience interference or failure.

26. The method of claim 16, further including the step of using an erasure-correcting encoding protocol.

27. The method of claim 26, wherein the erasure-correcting encoding protocol is based upon Fountain codes.
